(19) United States
(12) Patent Application Publication
(10) Pub. No.: US 2011/0246159 A1
(43) Pub. Date: Oct. 6, 2011

(54) Method and Apparatus to Build a Three-Dimensional Mechanical Earth Model

(76) Inventors: Jorg V. Herwanger, Richmond (GB); Madhumita Sengupta, Houston, TX (US)

(21) Appl. No.: 13/078,078

(22) Filed: Apr. 1, 2011

Related U.S. Application Data
(60) Provisional application No. 61/320,489, filed on Apr. 2, 2010.

(51) Int. Cl. G06G 7/48

(52) U.S. Cl. 703/7

(57) ABSTRACT

A technique includes inverting seismic data acquired for a subsurface region to determine dynamic elastic properties and converting the dynamic elastic properties to static elastic properties and rock strength properties. The technique includes generating a three-dimensional mechanical earth model for the subsurface region, where the model includes the dynamic elastic properties, the static elastic properties, the rock strength properties and a subsurface stress field. The technique can include a calibration step that matches seismic data observations to predictions from the geomechanical model.

This application claims the benefit under 35 U.S.C. §119(e) to U.S. Provisional Patent Application Ser. No. 61/320,489, entitled, “BUILDING A 3D MECHANICAL EARTH MODEL USING SEISMIC INVERSION, ROCK PHYSICS AND GEOMECHANICS,” which was filed on Apr. 2, 2010, and is hereby incorporated by reference in its entirety.

### BACKGROUND

The invention generally relates to method and apparatus to build a three- dimensional mechanical earth model.

A mechanical earth model (MEM) is a quantitative description of rock mechanical properties and in-situ stresses in the subsurface. Formation strength and in-situ stress are key components that impact well design. A MEM typically is used by geomechanics specialists for purposes of analyzing and optimizing solutions to drilling problems.

In general, the MEM quantifies the in-situ stresses, elastic properties and rock strength in the earth. Typically, the four major components of an MEM are the following: 1. lithology (including clay volume and porosity); 2. elastic and poro-elastic properties, such as Young's modulus, Poisson's ratio, bulk modulus, shear modulus and Biot's parameter; 3. rock strength (compressive and tensile strength, for example) and failure properties; and 4. in-situ stresses (stresses such as the overburden stress, tectonic stresses and pore pressure).

### SUMMARY

In an embodiment of the invention, a technique includes inverting seismic data acquired for a subsurface region to determine dynamic elastic properties and converting the dynamic elastic properties to static elastic properties and rock strength properties. The technique includes generating a three-dimensional mechanical earth model for the subsurface region, where the model includes the dynamic elastic properties, the static elastic properties, the rock strength properties and a subsurface stress field.

In another embodiment of the invention, a system includes an interface and a processor. The interface receives seismic data acquired for a subsurface region. The processor is coupled to the interface and is adapted to invert the seismic data to determine dynamic elastic properties; convert the dynamic elastic properties to static elastic properties and rock strength properties; and generate a three-dimensional mechanical earth model for the subsurface region, where the model includes the dynamic elastic properties, the static elastic properties, the rock strength properties and a subsurface stress field.

Advantages and other features of the invention will become apparent from the following drawing, description and claims.

### BRIEF DESCRIPTION OF THE DRAWING

FIG. 1 is an illustration of a three-dimensional (3-D) mechanical earth model (MEM) according to an embodiment of the invention.

FIG. 2 is an illustration of a subsurface region potentially containing a hydrocarbon field according to an embodiment of the invention.

FIGS. 3 and 4 are flow diagrams depicting techniques to construct a 3-D mechanical earth model (MEM) according to embodiments of the invention.

FIGS. 5 and 6 are flow diagrams depicting techniques to calibrate predicted stresses and strains of the 3-D MEM according to embodiments of the invention.

FIG. 7 is a schematic diagram of a data processing system according to an embodiment of the invention.

### DETAILED DESCRIPTION

Techniques and systems are disclosed herein to deterministically determine a three-dimensional (3-D) mechanical earth model (MEM) for a subsurface region based on log data derived from wells of the region and data acquired in a seismic survey of the region.

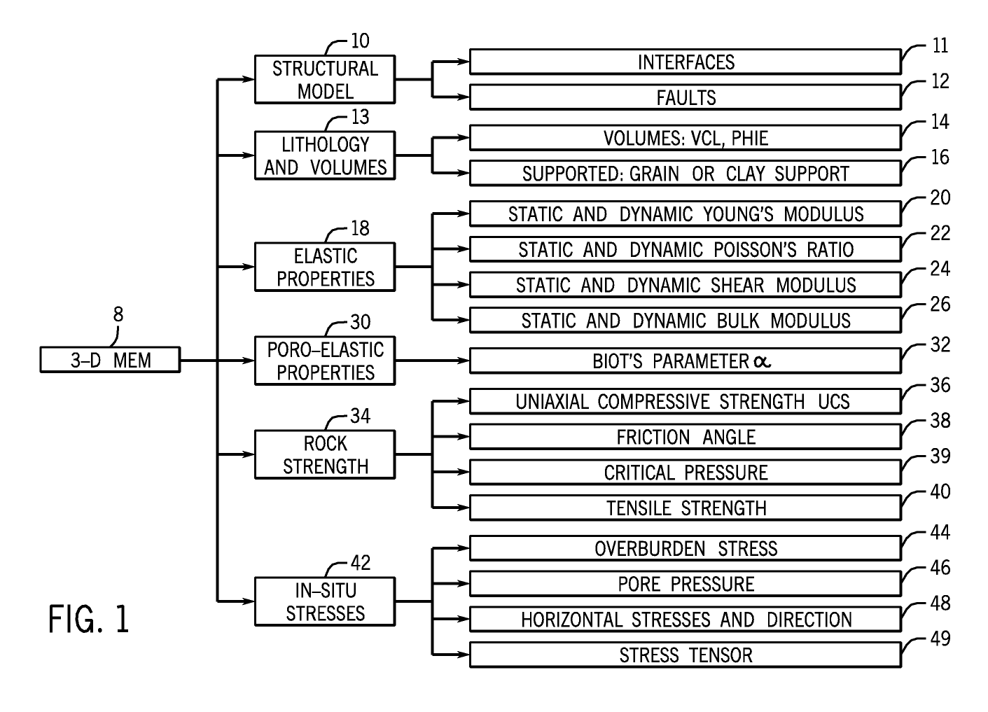

Referring to FIG. 1, as a non-limiting example, a 3-D MEM 8 in accordance with embodiments of the invention includes data indicative of rock mechanical properties and in-situ stresses and may be decomposed into its principal components as follows. The MEM 8 includes a structural model component 10, which contains an interfaces subcomponent 11 and a faults subcomponent 12; a lithology and volumes component 13, which includes a volumes subcomponent 14 of clay volumes (VCL) and the effective porosity (PHIE) and a subcomponent 16 identifying grain (e.g., sand) and clay support. The MEM 8 also contains an elastic properties component 18, which contains the following subcomponents: a static and dynamic Young's modulus subcomponent 20, a static and dynamic Poisson's ratio subcomponent 22, a static and dynamic shear modulus subcomponent 24 and a static and dynamic bulk modulus component 26. The MEM 8 further includes a poro-elastic properties component 30, which contains a Biot's parameter subcomponent 32. As also depicted in FIG. 1, the MEM 8 also contains a rock strength component 34, which has the following subcomponents: a uniaxial compression strength (UCS) subcomponent 36, a friction angle subcomponent 38 and a tensile strength subcomponent 40. The rock strength component 34 may further include a strength parameter that describes rock strength during compaction, such as, for example a critical pressure subcomponent 39. Finally, the MEM 8 includes an in-situ stresses component 42, which has the following subcomponents: an overburden stress subcomponent 44; a pore pressure subcomponent 46; a horizontal stresses and direction subcomponent 48; and a stress tensor component 49.

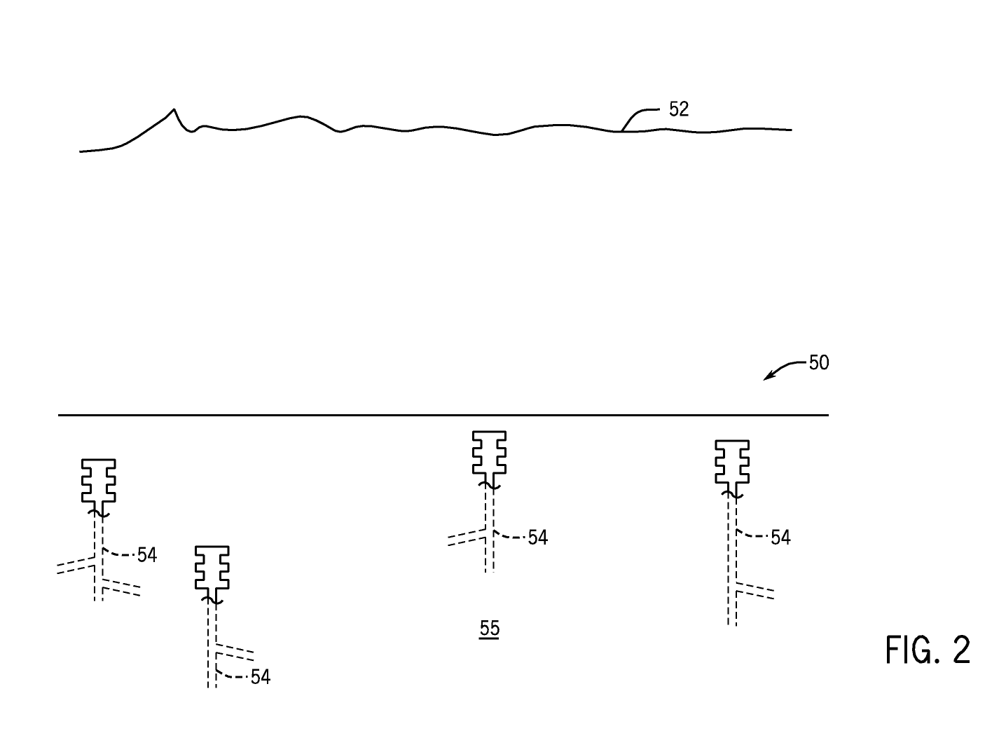

Referring to FIG. 2, as a non-limiting example, the 3-D MEM may be constructed from seismic survey data and well log data acquired from an exemplary subsea hydrocarbon field 50. As shown the subsea hydrocarbon field 50 includes various subsea wells 54, which are located on a seabed 55 beneath a sea-air surface 52. In this manner, logging operations have been conducted in the wells 54, and at least one seismic survey has been performed to acquire seismic survey data for the entire field 50.

As a non-limiting example, wellbore logging surveys may be conducted in the wellbore(s) of each of the wells 54 and may be performed, for example, by a wireline or string-deployed logging tool (a sonic-based tool, for example). As non-limiting examples, the seismic survey of the well field 50 may be conducted using a towed marine survey in which one or more surface vessels tow arrays of seismic streamers and sources; or the seismic survey of the field 50 may be conducted using ocean bottom cables (OBCs), which are deployed on the seabed 55.

Although FIG. 2 depicts a subsea well, it is noted that the systems and techniques that are disclosed herein may be applied to deterministically generate 3-D MEMs for non-subsea well field based on well and seismic survey data, in accordance with other embodiments of the invention.

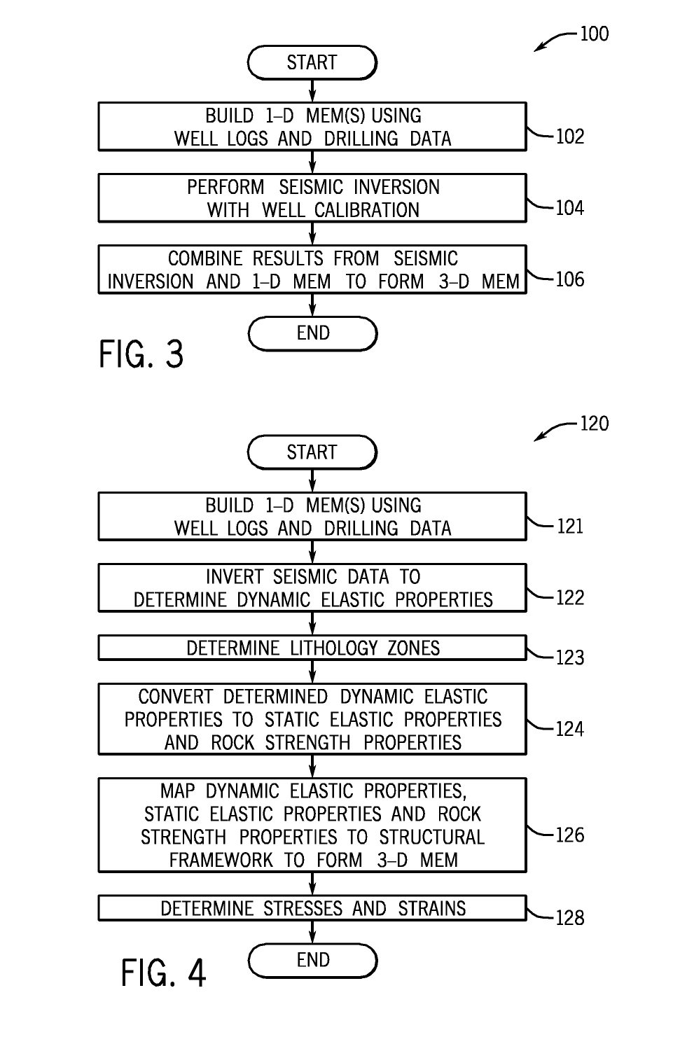

FIG. 3 depicts a technique 100 that may be used to construct a 3-D MEM for a hydrocarbon field in accordance with embodiments of the invention. Pursuant to the technique 100, a one-dimensional (1-D) MEM is constructed for each well in the well field using well logs and drilling data, pursuant to block 102. The 1-D MEM for a given well may be constructed using data that may be derived from many different sources, such as drilling reports, laboratory measurements, mud logs, logging while drilling (LWD) logs, wireline logs, seismic surveys, formation evaluation tests, completion tests, etc. In this regard, from this data, corresponding elastic properties, rock strength parameters, pore pressures and stresses along the wellbore of the well may be constructed for the 1-D MEM. The 1-D MEM may also be calibrated against laboratory measurements, field tests (leak off tests (LOTs), mini-frac tests, etc.) and the drilling performances of pre-existing wells.

In addition to building the 1-D MEM(s), the technique 100 also includes inverting (block 104) the seismic data and calibrating the inversion with well data, to determine dynamic elastic properties of the 3-D MEM. It is noted that steps 102 and 104 may be performed sequentially (in the order shown in FIG. 3 or in the reverse order) or may be performed in parallel, depending on the particular embodiment of the invention. Regardless of the processing order, the results from the 1-D MEM build and seismic inversion are combined, pursuant to block 106 to derive the 3-D MEM.

FIG. 4 depicts a more detailed technique 120 to construct a 3-D MEM in accordance with embodiments of the invention. Pursuant to the technique 120, a 1-D MEM is constructed for each well of the well field using associated well logs and drilling data, pursuant to block 121. Next, seismic data, which is acquired in a survey of the hydrocarbon field (3-D seismic data, as a non-limiting example) is inverted, pursuant to block 122 to determine dynamic elastic properties of the 3-D MEM. As a non-limiting example, prestack seismic data may be inverted for the dynamic elastic properties of the 3-D MEM using 3-D amplitude variation with offset (AVO) inversion, in accordance with some embodiments of the invention. Moreover the AVO inversion may be calibrated using well data, such as P-wave and S-wave sonic logs and density data. Next, according to the technique 120, the lithology zones are determined, pursuant to block 123 and then the dynamic elastic properties are converted (block 124) to the static and elastic properties and the rock strength properties of the 3-D MEM. Lastly, the stresses and strains of the 3-D MEM are determined, pursuant to block 128.

As mentioned above, for purposes of inverting the seismic data to determine the dynamic elastic properties, 3-D prestack AVO seismic inversion is used, in accordance with embodiments of the invention. In order to perform the AVO seismic inversion, a complete vertical section is needed from the earth's surface to the region below the reservoir. In other words, the inversion is not confined to a narrow depth zone around the target zone.

Therefore, in accordance with embodiments of the invention disclosed herein, the entire depth section is used, and AVO inversion is carried from the earth's surface downward to below the reservoir zone. For purposes of performing the AVO inversion, low frequency velocity and density models are first constructed. In a seismically-constructed MEM, the low frequency velocity and density models determine the estimated depth to target and vertical stress, respectively. Checkshot data, if available, may be used to constrain shallow velocity/density models. Extending the seismic inversion to the earth's surface, may not be straightforward, because the shallow density and velocity data for calibration at low frequency model building are usually not readily available. Therefore, in accordance with embodiments of the invention, well-calibrated rock physics-based compaction trends may be used as a guide to extend a low frequency model up to the earth's surface. The superposition of the compaction trend overcomes the deficiencies of the information provided by well logging data, because the shallow overburden is very rarely logged. A purely well-based model would also fail away from the wells, in a situation where all of the wells are clustered together in one place and water depths are varying.

Because the 3-D MEM is indexed by depth, seismic velocities are used to convert the inversion volumes from time to depth. If the velocity data quality is relatively poor, check-shots and well markers may be used for the time-to-depth conversion. Ideally, the seismic velocity volume is constrained using check-shot information at the wells, in accordance with some embodiments of the invention.

After the 3-D AVO inversion is used to determine the dynamic elastic properties for the 3-D MEM, the next step in the construction of the 3-D MEM is the creation of lithology zones or units. A zonation into sand and shale intervals is used, because different relationships between dynamic and static moduli apply for grain-supported (i.e., sand) and clay-supported zones.

As a non-limiting example, the well log data may show that sands have lower acoustic (P-) and shear (S-) impedances than shales. Therefore, for this example, the P- and S-impedances that are obtained from the seismic AVO inversion may provide a sufficient lithology discrimination in the reservoir target zone and in the overburden. Moreover, based on the analysis of the well log data, it may be determined that the acoustic impedance is a good indicator of total porosity. Thus, to compute porosity, a simple linear regression based on the well log data may be used to estimate the total porosity from the acoustic impedance. Other techniques may be used to determine the lithology zones, in accordance with other embodiments of the invention. For example, it may be possible to perform a more sophisticated lithology estimation based on clustering techniques, distant measures or statistical rock physics approaches, in accordance with other embodiments of the invention.

The above-described lithology estimation approach helps to establish the work flow of building the 3-D MEM from the seismic AVO inversion. The static elastic moduli of the 3-D MEM are used to predict rock deformation, as the mechanical (static elastic moduli and strength) properties and in-situ stresses are needed to predict deformation and the failure of rocks. The static elastic properties of the 3-D MEM may be determined from the dynamic elastic properties using statistical relationships between the properties. As a non-limiting example, these statistical relationships may be developed from laboratory measurements for each lithology unit. In accordance with some embodiments of the invention, the same transforms that relate dynamic elastic moduli to geomechanical properties (i.e., static elastic moduli and rock strength properties) for 1-D MEMs (built from well logs) are used to determine the static elastic properties for the 3-D MEM (built from 3-D prestack seismic AVO inversion).

As a non-limiting example, it may be assumed that the static Poisson's ratio is equal to the dynamic Poisson ratio. This is a reasonable assumption, because the laboratory measurements indicate that the difference between the static and dynamic Poisson's ratio are negligible. For example, laboratory tests show that typical values of Poisson's ratio in certain sands are in the order of 0.192 to 0.32 for both the static and dynamic Poisson's ratio. However, the calculated values using sonic and P-wave and S-wave measurements produce values in the range of 0.40 to 0.44. Based on the laboratory observations, the sands may be attributed a constant Poisson's ratio at 0.31 in the 1-D MEM, in accordance with some embodiments of the invention. Other relations between the static and dynamic Poisson's ratios may be used, in accordance with other embodiments of the invention. In the 1-D MEM study, the chance of Poisson's ratio was shown to have important consequences on the assessment of the depletion effects and is another major source of uncertainty.

To calculate the rock strength parameters, the following transforms may be used. For shales, as a non-limiting example, the Horsrud correlation may be used, which is the same correlation used in the construction of the 1-D MEM. The Horsrud correlation is generally disclosed in Horsrud, P., Estimating Mechanical Properties of Shale from Empirical Correlations, SPE 56017 (2001), which is hereby incorporated by reference in its entirety. For sands, a laboratory-calibrated correlation based on dynamic elastic properties (Young's modulus and Poisson's ratio) may be used to derive rock strength. The friction angle, derived from laboratory-calibrated relationships, may be, for example, a function of porosity and clay content.

The stresses and strains of the 3-D MEM may be determined using finite element stress analysis software, in accordance with some embodiments of the invention. In this regard, the finite element analysis software determines stresses and strains based on the static elastic properties and the strength properties. The overburden stress is determined by integrating the formation density from the mudline to the depth of interest, plus the weight per unit area of the water column. The pore pressure may be calculated using a constant pore-pressure gradient, as per the 1-D MEM(s). The seismic data may be used to constrain the pore pressure determination when overpressure is determined to be a significant issue. Pore pressure estimation using seismic data is generally described in, for example, Huffman, A. R., The Future of Pore-Pressure Prediction Using Geophysical Methods, The Leading Edge 21, pp. 199-205 (2002); and Sayers, C. M., An Introduction to Velocity-Based Pore-Pressure Estimation, The Leading Edge 25,pp. 1496-1500 (2006), each of which is hereby incorporated by reference in its entirety.

The spatially varying stress field can be estimated by mathematical analysis (a finite element analysis, as a non-limiting example), using the spatially varying density, static elastic properties and strength properties.

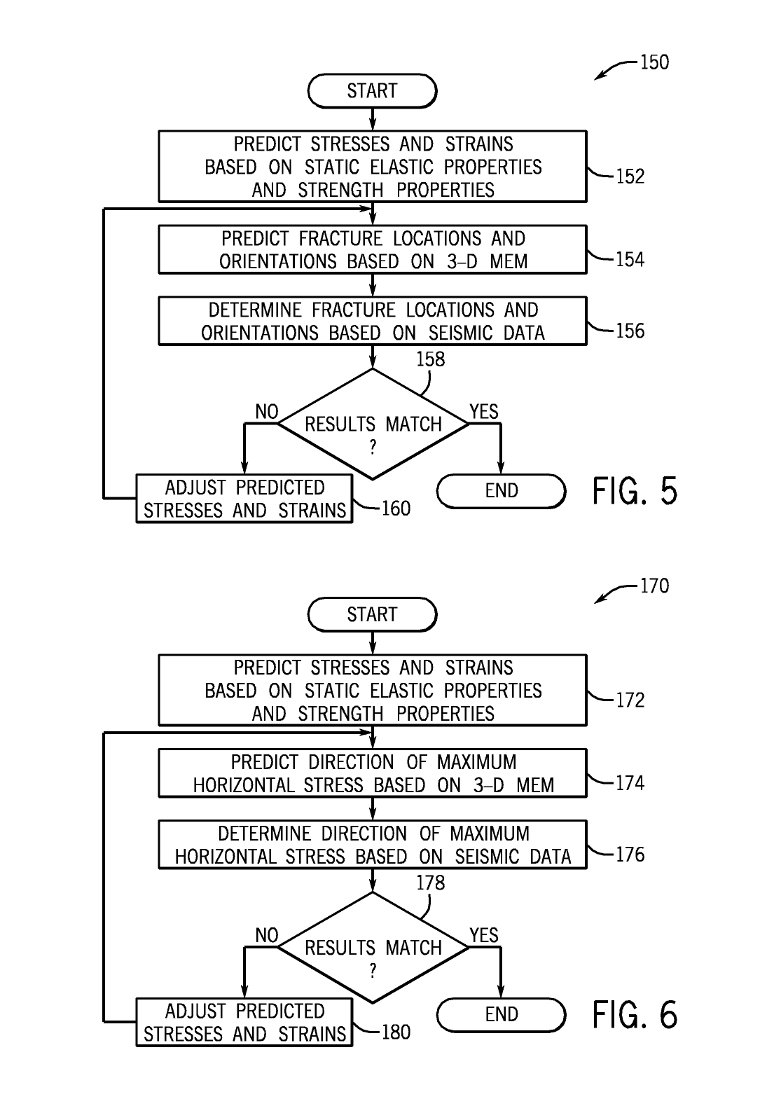

The above-described computed strains and stresses are predictions, which may be right or wrong. Therefore, in accordance with some embodiments of the invention, the stress and strain predictions may be tested with data observations for purposes of calibrating the predictions. Referring to FIG. 5, in accordance with a particular embodiment of the invention, a technique 150 includes predicting (block 152) stresses and strains based on static elastic properties and strength properties and then performing steps to calibrate these predictions. In this manner, the technique 150 includes predicting (block 154) fracture locations and orientations based on the 3-D MEM derived using the predicted stresses and strains, pursuant to block 154. The fracture locations and orientations are also determined, pursuant to block 156, based on the seismic data, such as using the technique disclosed in Bachrach, R., Sengupta, M., Salama, A., and Miller, P., 2009, Reconstruction of Layer Anisotropic Elastic Parameters and High-Resolution Fracture Characterization From P-Wave Data: A Case Study Using Seismic Inversion and Bayesian Rock-Physics Parameter Estimation, Geophysical Prospecting 57, 253-262 2009), which is hereby incorporated by reference in its entirety. If the results substantially match (diamond 158) (for example, if the fracture locations and orientations predicted by the 3-D MEM with the estimated stresses and strains are within some error of the fracture locations and orientations determined by the seismic data), then the calibration is complete. Otherwise, if the observed and predicted results do not substantially match, the predicted stresses and strains are adjusted, pursuant to block 160, and control returns to block 154 for another iteration to refine the predicted stresses and strains.

FIG. 6 depicts an alternative technique 170, in accordance with other embodiments of the invention, for purposes of calibrating the predicted stresses and strains. Pursuant to the technique 170, the stresses and strains are first predicted (block 172) based on static elastic properties and the strength properties. Next, the resulting 3-D MEM derived using these predicted stresses and strains is then used to predict (block 174) the direction of maximum horizontal stress. The direction of maximum horizontal stress is also determined, pursuant to block 176, based on the seismic data. In this manner, it may be assumed that this direction coincides with the direction of maximum horizontal P-wave velocity; and the direction of maximum horizontal P-wave velocity may be determined from azimuthal NMO (normal moveout velocity) analysis or azimuthal AVO (Amplitude versus Offset) analysis If the results substantially match (for example, if the direction of maximum horizontal stress predicted by the 3-D MEM with the estimated stresses and strains are within some error of the direction of maximum horizontal stress determined by the seismic data), then the predicted stresses and strains are correct and no further calibration occurs. If, however, the results do not substantially match (pursuant to diamond 178), then the predicted stresses and strains are adjusted, pursuant to block 180 and control returns to block 174.

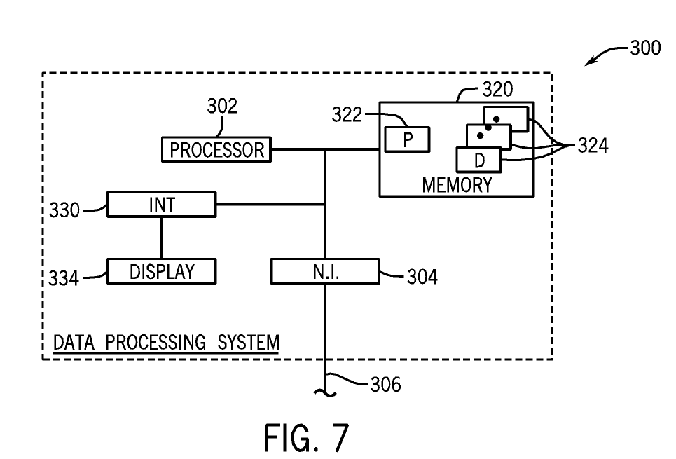

Referring to FIG. 7, in accordance with some embodiments of the invention, the above-described technique to determine the 3-D MEM may be implemented all or in part on a data processing system 300. In general, the data processing system 300 includes a processor 302, which may be may be one or more central processing unit (CPUs), one or more processing cores, etc. depending on the particular implementation.

In general, the processor 302 is coupled to an interface 304 (a network interface, as a non-limiting example), for purposes of receiving seismic data as well as receiving data indicative of one or more 1-D MEMs, data indicative of correlations between dynamic and elastic properties, WAZ seismic data, etc. The processor 302 processes this data according the techniques 100, 150 and/170, in accordance with embodiments of the invention to produce one or more initial, intermediate or final datasets 324, which may be stored in a system memory 320. As examples, the memory 320 may be a non-transitory semiconductor memory, volatile memory, non-volatile memory, optical storage, magnetic storage, etc., depending on the particular embodiment of the invention. In addition to the datasets 324, the memory may also store various program instructions 322, which when executed by the processor 302, cause the processor 302 to perform one or more parts of the techniques 100, 150 and/or 170, in accordance with the various embodiments of the invention.

As also depicted in FIG. 7, initial, intermediate or final results obtained through the processing by the processor 302 may be displayed on a display 334 of the data processing system 300. In this regard, as depicted in FIG. 7, an interface 330 of the data processing system 300 may couple the display 334 to the processor 302.

It is noted that the architecture depicted in FIG. 7 is merely as an example of one out of many possible computer architectures that may be used for purposes of performing the techniques that are disclosed herein. Moreover, the techniques that are disclosed herein may be performed on multiple processing systems and may be performed on distributed processing systems, in accordance with other implementations. Thus, many variations are contemplated and are within the scope of the appended claims.

Other embodiments are contemplated and are within the scope of the appended claims. For example, in accordance with other embodiments of the invention, a 3-D MEM may be constructed for a subsurface region other than a region that contains a hydrocarbon field. As non-limiting examples, the systems and techniques that are disclosed herein may be used for purposes of constructing a 3-D MEM for such subsurface regions as carbon dioxide sequestration fields, geothermal fields, etc.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. A method comprising:
inverting seismic data acquired for a subsurface region to determine dynamic elastic properties;
converting the dynamic elastic properties to static elastic properties and rock strength properties; and
generating a three-dimensional mechanical earth model for the subsurface region, the model comprising the dynamic elastic properties, the static elastic properties, the rock strength properties and a subsurface stress field.

2. The method of claim 1, wherein the subsurface region comprises at least one well, a hydrocarbon field, a carbon dioxide sequestration region, or a geothermal field.

3. The method of claim 1, wherein the subsurface region comprises at least one well, the method further comprising:
determining a one-dimensional mechanical earth model for said at least one well based on well log data acquired for said at least one well, wherein
the generation of the three-dimensional model is based in part on the one-dimensional mechanical earth model.

4. The method of claim 3, further comprising:
determining a compaction trend based at least in part on the one-dimensional mechanical earth model;
determining a low frequency model extending to the Earth surface based on the compaction trend; and
using the low frequency model in the inversion of the seismic data.

5. The method of claim 4, wherein the low frequency model comprises a velocity model or a density model.

6. The method of claim 3, further comprising:
determining a lithology for the three-dimensional mechanical earth model based at least in part on the one-dimensional mechanical earth model.

7. The method of claim 6, wherein the converting is based in part on the determined lithology.

8. The method of claim 1, wherein the converting is based at least in part on predetermined correlations interrelating the static elastic properties to the dynamic elastic properties and interrelating the rock strength properties to the dynamic elastic properties.

9. The method of claim 1, further comprising:
determining stresses and strains for the three-dimensional model based at least in part on the static elastic properties and the rock strength properties.

10. The method of claim 9, wherein the act of determining comprises:
predicting the stresses and strains based at least in part on the static elastic properties and the rock strength properties; and
calibrating the prediction based at least in part on results derived from the seismic data.

11. The method of claim 10, wherein the calibrating comprises:
predicting fracture orientations and locations based on a three-dimensional model that is based in part on the predicted stresses and strains;
determining fracture orientations and locations based on the seismic data; and
adjusting the prediction based on a comparison of the fracture orientations determined from the seismic data with the fracture orientations and locations predicted by the three-dimensional model.

12. The method of claim 10, wherein the calibrating comprises:
predicting a direction of maximum horizontal stress based on a three-dimensional model that is based in part on the predicted stresses and strains;
determining a direction of maximum horizontal stress based on the seismic data; and
adjusting the prediction based on a comparison of the maximum horizontal stress determined from the seismic data with the direction of maximum horizontal stress predicted by the three-dimensional model.

13. A system comprising:
an interface to receive seismic data acquired for a subsurface region; and
a processor coupled to the interface and adapted to:
invert the seismic data to determine dynamic elastic properties;
convert the dynamic elastic properties to static elastic properties and rock strength properties; and
generate a three-dimensional mechanical earth model for the subsurface region, the model comprising the dynamic elastic properties, the static elastic properties, the rock strength properties and a subsurface stress field.

14. The system of claim 13, wherein the subsurface region comprises at least one well, a hydrocarbon field, a carbon dioxide sequestration region, or a geothermal field.

15. The system of claim 13, wherein the subsurface region comprises at least one well and the processor is further adapted to generate the three-dimensional mechanical earth model based at least in part on a one-dimensional mechanical earth model for said at least one well based on well log data acquired for said at least one well.

16. The system of claim 15, wherein the processor is further adapted to:
determine a compaction trend based at least in part on the one-dimensional mechanical earth model;
determine a low frequency model extending to the Earth's surface based on the compaction trend; and
use the low frequency model in the inversion of the seismic data.

17. The system of claim 16, wherein the low frequency model comprises a velocity model or a density model.

18. The system of claim 15, wherein the processor is further adapted to determine a lithology for the three-dimensional mechanical earth model based at least in part on the one-dimensional mechanical earth model.

19. The system of claim 18, wherein the processor is adapted to perform the conversion based at least in part on the determined lithology.

20. The system of claim 13, wherein the processor is further adapted to convert the dynamic elastic properties to static elastic properties and rock strength properties based at least in part on predetermined correlations interrelating the static elastic properties to the dynamic elastic properties and interrelating the rock strength properties to the dynamic elastic properties.

21. The system of claim 13, wherein the processor is further adapted to determine stresses and strains for the three-dimensional model based at least in part on the static elastic properties and the rock strength properties.

22. The system of claim 21, wherein the processor is further adapted to:
predict the stresses and strains based at least in part on the static elastic properties and the rock strength properties; and
calibrate the prediction based at least in part on results derived from the seismic data.

23. The system of claim 22, wherein the processor is further adapted to calibrate the prediction by:
predicting fracture orientations and locations based on a three-dimensional model that is based in part on the predicted stresses and strains;
determining fracture orientations and locations based on the seismic data; and
adjusting the prediction based on a comparison of the fracture orientations determined from the seismic data with the fracture orientations and locations predicted by the three-dimensional model.

24. The system of claim 22, wherein the processor is further adapted to calibrate the prediction by:
predicting a direction of maximum horizontal stress based on a three-dimensional model that is based in part on the predicted stresses and strains;
determining a direction of maximum horizontal stress based on the seismic data; and
adjusting the prediction based on a comparison of the maximum horizontal stress determined from the seismic data with the direction of maximum horizontal stress predicted by the three-dimensional model.

25. An article comprising a computer readable storage medium to store instructions that when executed by a computer causes the computer to:
invert seismic data acquired for a subsurface region to determine dynamic elastic properties, the well field comprising at least one well;
convert the dynamic elastic properties to static elastic properties and rock strength properties; and
generate a three-dimensional mechanical earth model for the subsurface region, the model comprising the dynamic elastic properties, the static elastic properties, the rock strength properties and a subsurface stress tensor.
